(19) United States
(12) Patent Application Publication
(10) Pub. No.: US 2011/0155259 A1
(43) Pub. Date: Jun. 30, 2011

(54) CONTROL ARRANGEMENT HAVING A PRESSURE LIMITING VALVE

(76) Inventors: Wolfgang Volpert, Gemuenden (DE); Georg Schoppel, Lohr am Main (DE)

(21) Appl. No.: 13/000,750

(22) PCT Filed: May 12, 2009
(86) PCT No.: PCT/EP09/03347

§ 371 Date: Mar. 4, 2011

(30) Foreign Application Priority Data
Jun. 23, 2008 (DE) 10 2008 029 641.4

(51) Int. Cl. F16K 17/00

(52) U.S. Cl. 137/87.04; 137/87.03

(57) ABSTRACT

The invention relates to a control arrangement having a pressure limiting valve or a proportional throttle valve, having a control device allowing volume flow control. In addition to the pressure limiting function, an identical valve can thus also be used as a flow control valve for high volume flows.

The invention relates to a control arrangement having a pressure limiting valve or a proportional throttle valve as generically defined by the preamble to claim 1.

Flow regulating valves have the object of keeping a set volumetric flow constant, regardless of pressure fluctuations. To that end, besides a measuring throttle restriction, a movable throttle restriction is provided, which functions as a pressure scale and at the same time acts as a comparison member in a closed control circuit. The maximum volume flow is limited because of the principle of the pressure scale, and there is the risk that vibration will be generated in the system.

From German Patent DE 37 34 955 C2, an apparatus for electrical measured value processing for a multiposition regulating valve is known, in which an intermediate plate is provided, for communication among bores of the multiposition regulating valve and the pressure fluid source, the tank, and work lines. Pressure measuring devices for detecting a pressure on the inlet and/or the outlet side are provided in the intermediate plate, and their output signals, via a processing device, can be used for instance to keep a predetermined flow rate constant. Because of the many hydraulic ports on the regulating valve, the equipment expense for implementing the flow regulating function is high.

The object of the present invention is to create a control arrangement by way of which a flow regulating function can be implemented at little expense for equipment and with a maximum volume flow.

This object is attained by a control arrangement having a proportional pressure limiting valve or a proportional throttle valve as defined by claim 1.

A control arrangement with a proportional pressure limiting valve or proportional throttle valve is provided, which has a control device by way of which the valve can be triggered in the sense of flow regulation. In this way, the vulnerability to vibration of conventional flow regulating valves with a pressure scale can be avoided, and high volume flows can be implemented at little expense for equipment.

It is preferable if the control device calculates a desired valve value as a function of a pressure difference above the valve and a desired volume flow. This enables it to be used as a flow regulator on the basis of only a performance graph implemented in the control device.

In an alternative, the control device has a regulator for the desired valve value, to which the desired volume flow and a volume flow, ascertained via a performance graph from the pressure difference above the valve and the desired valve value can be delivered. In such an embodiment, it is advantageous that an ascertained actual volume flow is present, and despite the use of a regulator, a calculator with an implemented performance graph can be employed.

In a further alternative, the control device has a regulator for a desired valve value, to which regulator the pressure difference above the valve and a pressure difference ascertained via a performance graph from the desired volume flow and the desired valve value can be delivered. In this implementation, a desired value for the pressure difference is formed from the desired value for the volume flow and is compared with the actual value for the pressure difference. Thus additional process information is available for estimating the operation of the control device.

The control device can have a measuring device for the pressure difference above the valve, so that the flow regulator can be implemented at little expense for equipment.

If one pressure measuring device is used for the pressure upstream and one pressure measuring device for the pressure downstream of the valve, then besides the flow regulating function, the pressure limiting function can be employed with additional measured values.

If a pilot-controlled pressure limiting valve is used in the control arrangement, higher volume flows can be attained, which can also be implemented with regard to the flow regulating function.

The pressure limiting valve is preferably a proportional pressure limiting valve, as a result of which, if there is a change in the desired valve value, a fast change in the pressure difference above the pressure limiting valve is possible.

The direct-controlled proportional pressure limiting valves used for pilot control in proportional throttle valves and proportional pressure limiting valves fundamentally have hysteresis. Unless other provisions are made, this hysteresis has a direct effect on the described flow regulating function, so that in both the desired value volume flow characteristic curve and the input and output pressure dependency, courses with hysteresis can result.

This (adverse) property can be counteracted by establishing an unambiguous association between the desired value U_{D} and the pilot control pressure pₓ on the back side of the main piston or main slide.

This can be done for instance by using proportional pressure limiting valves with regulation of the armature position for the pilot control. These valves fundamentally have little or no hysteresis, so that the described effects do not arise.

A second possibility can be implementing a regulator of the pilot control pressure. Detecting the pilot control pressure pₓ via an additional pressure sensor makes the underlying regulation or followup of the desired value U_{D} possible, in such a way that the described hysteresis effects can be eliminated internally in the equipment.

The subject of the dependent claims is a refinement according to the invention.

The present invention will be described below in conjunction with schematic drawings, in which:

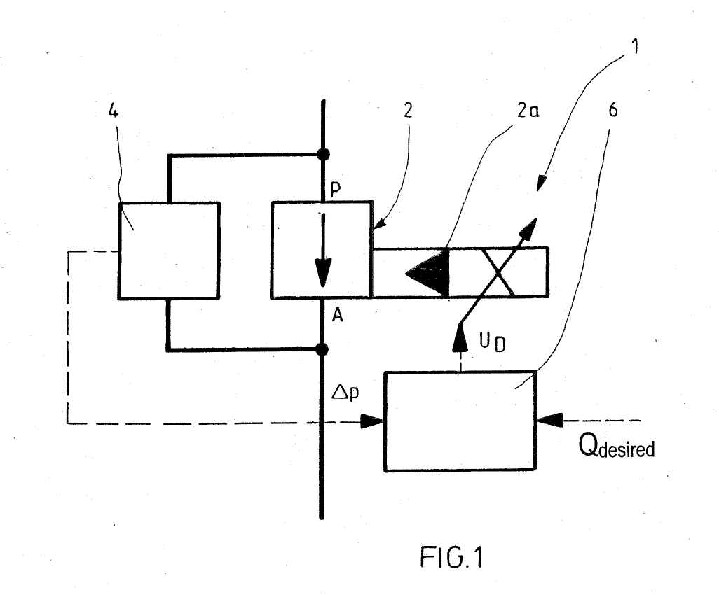

FIG. 1 shows a control arrangement in a first exemplary embodiment of the invention;

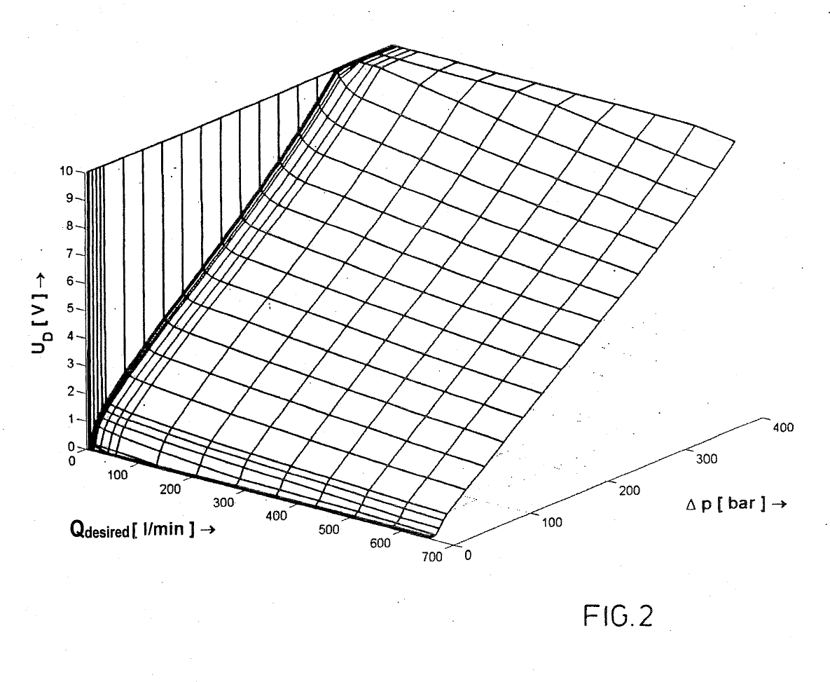

FIG. 2 shows a performance graph for a control arrangement in the first exemplary embodiment of the invention;

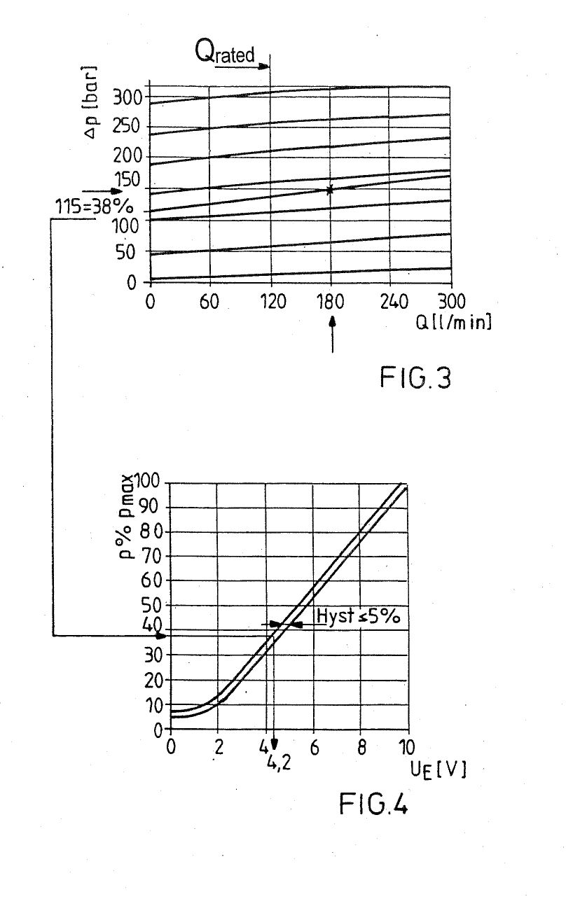

FIGS. 3 and 4 show characteristic curves for the pressure difference over the volume flow as well as percentages of the pressure over the control current or the control voltage of a pressure limiting valve in the prior art;

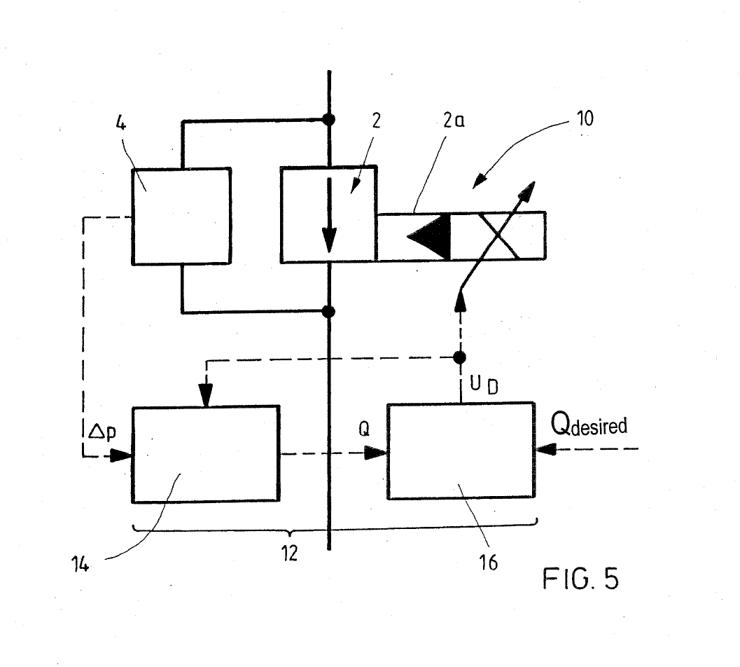

FIG. 5 shows a control arrangement in the second exemplary embodiment of the invention;

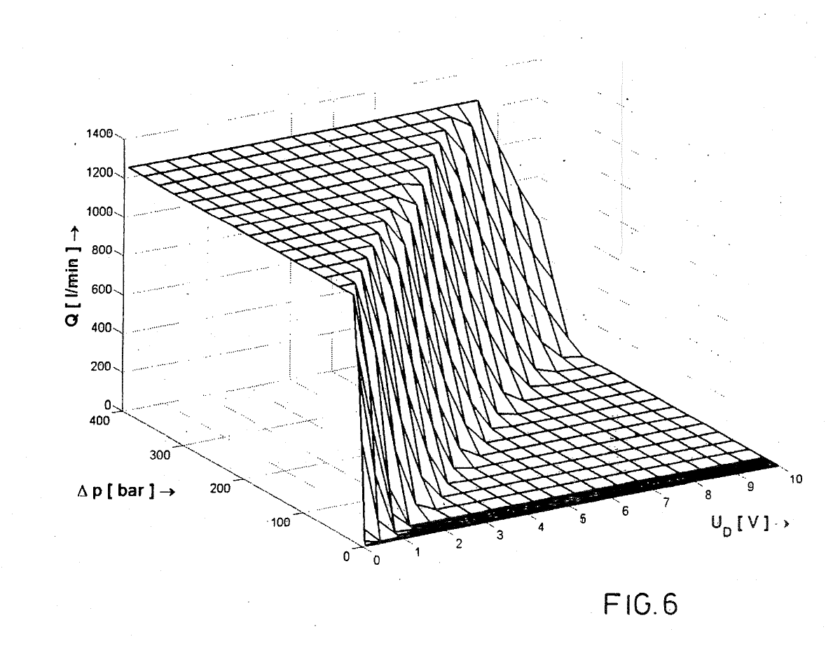

FIG. 6 shows a performance graph for a control arrangement in the second exemplary embodiment of the invention;

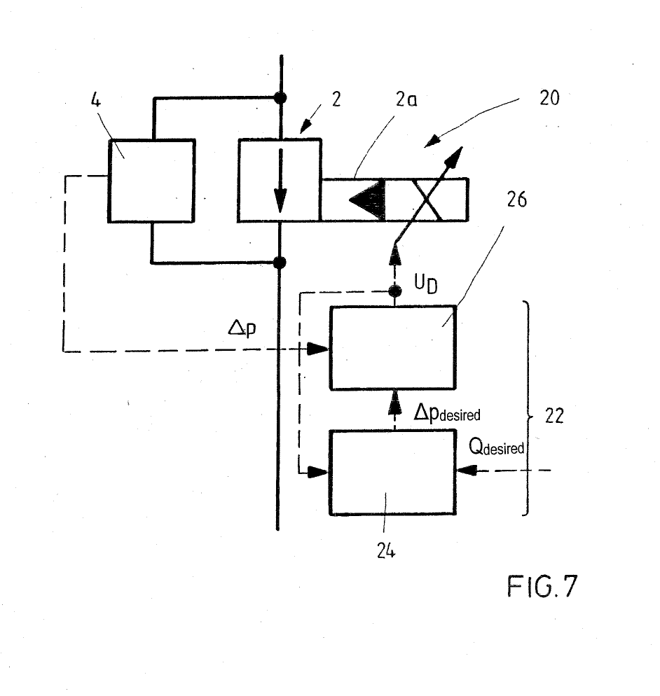

FIG. 7 shows a control arrangement in the third exemplary embodiment of the invention; and

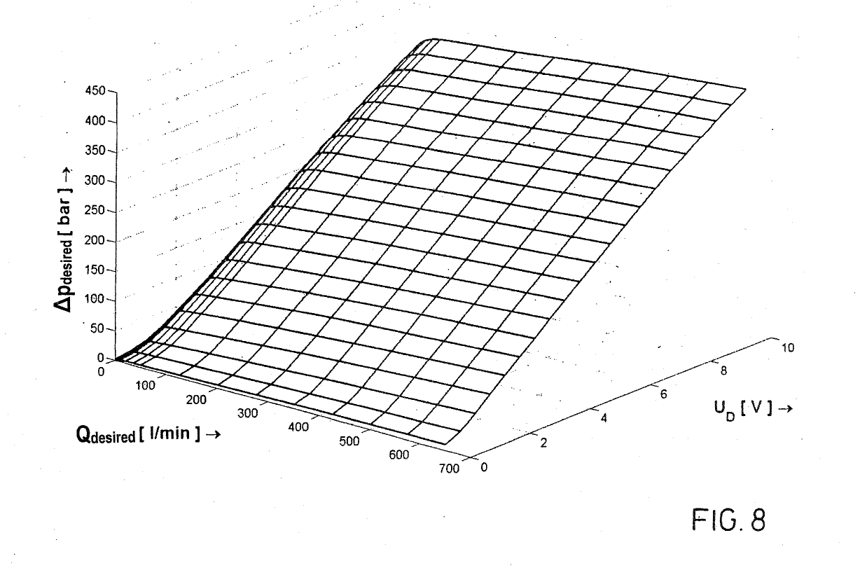

FIG. 8 shows a performance graph for a control arrangement in the third exemplary embodiment of the invention.

The control arrangement 1 shown in FIG. 1 in the first exemplary embodiment has a pilot-controlled proportional pressure limiting valve 2 with a pump port P and a work port A, a differential pressure meter 4, and a control device 6.

The pressure difference between the pump port P and the work port A is determined by the differential pressure meter 4, whose output signal Δp is delivered to the control device 6. As a further input signal, the control device 6 receives a desired volume flow Q_{Soll}. From the input variables Δp and Q_{Soll}, the control device 6 calculates a desired valve value in the form of a control voltage U_{D}, which is delivered to an electromagnet of the pilot control valve 2a of the pressure limiting valve 2.

A performance graph, shown as an example in FIG. 2, is stored in memory in the control device 6, and the pressure difference, the volume flow Q_{Soll} and the desired valve value U_{D} are shown on its axes. This performance graph is obtained by inversion from the relationship, shown in FIG. 8, between the desired valve value U_{D}, the volume flow Q, and the resultant pressure difference Δp. The prerequisite for the possibility of the inversion is that in the characteristic curve in FIG. 8, the pressure Δp increases monotonically over the volume flow. This condition is met as a rule in directly controlled valves. In pilot-controlled pressure limiting valves, such a characteristic curve can be realized if there is internal control oil.

Putting the performance graph of FIG. 2 upstream of the proportional pressure limiting valve 2 makes it possible for a pilot-controlled proportional pressure limiting valve, of the kind shown for instance in the Rexroth Bosch Group RD-Merkblatt 29140/07.05, can be used as a flow regulator. For a predetermined desired value Q_{Soll} for the volume flow, the desired valve value U_{D} can be ascertained from the measured pressure difference Δp.

In FIGS. 3 and 4, from the aforementioned RD-Merkblatt 29140/07.05, the dependency of the pressure difference Δp on the volume flow Q on the one hand and the dependency of a percentage for the pressure on the desired value for the valve voltage U_{E} or for the valve current I_{E}, on the other, are shown. These characteristic curves are used below as examples for describing control in the control device 6 in accordance with the present invention:

The pressure limiting valve 2 is located for instance between a pump at the pump port P and a hydraulic consumer at the work port A. Via the differential pressure meter, a pressure difference Δp, for instance of 150 bar, is ascertained. If a desired volume flow of 180 l/min is specified, then from the kid of FIG. 3, with the associated Q/p curve, a desired pressure value to be set of 115 bar is the result. This is equivalent to approximately 38% of the maximum rated pressure, and as a result in FIG. 4, a desired valve value of 4.2V is obtained.

In FIG. 5, a control arrangement 10 is shown, with a pressure limiting valve 2 and a differential pressure meter 4. Unlike the first exemplary embodiment, the control device 12 has a calculator 14 and a regulator 16. In the calculator 14, from the pressure difference Δp of the differential pressure meter 4 and the desired valve value U_{D}, the volume flow Q is ascertained, via a performance graph shown in FIG. 6. The volume flow obtained is delivered to the regulator 16 and compared with the desired value Q_{Soll} for the volume flow. From the control deviation a corresponding desired valve value U_{D} is obtained, which is carried to the pilot control valve 2a.

In the control arrangement of the second exemplary embodiment, the volume flow Q is measured indirectly, and a signal for the desired valve value U_{D} is output by the regulator 16, so that in the ideal case, the actual value Q for the volume flow, obtained via the calculation unit 14, is equal to the desired value Q_{Soll} for the volume flow. The performance graph of FIG. 6 shows the calculated actual value Q for the volume flow as a function of the measured pressure difference Δp at the pressure meter 4 and as a function of the desired valve value U_{D}. The performance graph of FIG. 6 can be obtained from that of FIG. 8 by inversion as well.

FIG. 7 shows a control arrangement 20 in the third exemplary embodiment, with a pressure limiting valve 2 and a differential pressure meter 4. The control device 22 has a calculator 24 and a regulator 26. In the calculator 24, the performance graph shown in FIG. 8, for example, is implemented. The performance graph of FIG. 8 represents the pressure difference Δp_{Soll} as a function of the desired volume flow Q_{Soll} and of the desired valve value U_{D}. The ascertained desired volume flow Δp_{Soll} is compared in the regulator 26 with the actual value for the pressure difference Δp, and from those variables, the desired valve value U_{D} is ascertained, which is carried to the pilot control valve 2a of the pressure limiting valve 2. In this way, a pressure difference regulation takes place, in which the desired value Δp_{Soll} for the pressure difference is derived from the desired value for the volume flow Q_{Soll} and from the desired valve value U_{D}.

With a control arrangement according to the invention, a flow regulator can be implemented, with the same mechanical hardware as a directly controlled or pilot-controlled limiting valve. The change in the regulating behavior is due to a different behavior of the control device. While in conventional flow regulator valves with a pressure scale, a volume flow of 160 liters per minute can for instance be implemented, by the use of pressure limiting valves as flow regulators a volume flow of 250 or 650 liters per minute, for instance, can be attained.

Even greater freedoms in design are obtained if the differential pressure meter 4 is replaced by one pressure transducer each at the pump port P and at the work port A. By way of suitable evaluation electronics, the differential pressure for implementing the control arrangement of the first through third exemplary embodiments can be implemented. Thus in addition to the flow regulation function by means of a control arrangement of this kind, a pressure limiting function with regulation of the limited pressure at the work port A and a pressure limiting function with regulation of the pressure difference Δp can be implemented. For the flow regulation function and the pressure limiting function, the same valve types can consequently be employed hydraulically.

Moreover, with the use of a calculator 14 of the second exemplary embodiment of FIG. 5, an indirect measured value for the volume flow Q can be generated from the measured pressures and the desired valve value U_{D}. Because of the coupling with the control device, the scope of function of dos can thus be expanded.

The present invention is not limited to use with pressure limiting valves; proportional throttle valves can also be used.

A control arrangement with a pressure limiting valve or a proportional throttle valve is disclosed, in which a control device is provided that makes a flow regulator function mode of the control arrangement possible. Besides the pressure limiting function, a structurally identical valve can thus be used as a flow regulator valve for high volume flows.

### LIST OF REFERENCE NUMERALS

1 Control arrangement
2 Pressure limiting valve
2a Pilot control valve
4 Differential pressure meter
6 Control device
10 Control arrangement
12 Control device
14 Calculator
16 Regulator
20 Control arrangement
22 Control device
24 Calculator
26 Regulator

1-11. (canceled)

12. A control arrangement, having a pressure limiting valve or a proportional throttle valve and a control device, by way of which control device the valve is triggered by flow regulation.

13. The control arrangement as defined by claim 12, wherein the control device calculates a desired valve value as a function of a pressure difference above the valve and of a desired volume flow.

14. The control arrangement as defined by claim 13, wherein the control device has a regulator for the desired valve value, to which the desired volume flow and a volume flow, ascertained via a performance graph from the pressure difference above the valve and the desired valve value can be delivered.

15. The control arrangement as defined by claim 13, wherein the control device has a regulator for the desired valve value, to which the pressure difference above the valve and a pressure difference ascertained via a performance graph from the desired volume flow and the desired valve value can be delivered.

16. The control arrangement as defined by claim 13, having a measuring device for the pressure difference above the valve.

17. The control arrangement as defined by claim 14, having a measuring device for the pressure difference above the valve.

18. The control arrangement as defined by claim 15, having a measuring device for the pressure difference above the valve.

19. The control arrangement as defined by claim 12, having one pressure measuring device for pressure upstream of the valve and one pressure measuring device for pressure downstream of the valve.

20. The control arrangement as defined by claim 13, having one pressure measuring device for pressure upstream of the valve and one pressure measuring device for pressure downstream of the valve.

21. The control arrangement as defined by claim 14, having one pressure measuring device for pressure upstream of the valve and one pressure measuring device for

22. The control arrangement as defined by claim 15, having one pressure measuring device for pressure upstream of the valve and one pressure measuring device for pressure downstream of the valve.

23. The control arrangement as defined by claim 12, wherein the valve is a pilot-controlled pressure limiting valve.

24. The control arrangement as defined by claim 14, wherein the valve is a pilot-controlled pressure limiting valve.

25. The control arrangement as defined by claim 15, wherein the valve is a pilot-controlled pressure limiting valve.

26. The control arrangement as defined by claim 12, wherein the valve is directly controlled pressure limiting valve.

27. The control arrangement as defined by claim 13, wherein the valve is directly controlled pressure limiting valve.

28. The control arrangement as defined by claim 23, wherein the pressure limiting valve is a proportional pressure limiting valve.

29. The control arrangement as defined by claim 26, wherein the pressure limiting valve is a proportional pressure limiting valve.

30. The control arrangement as defined by claim 23, wherein for minimizing hysteresis of the pilot-controlled pressure limiting valve, a magnet armature of a pilot control valve with underlying position regulation is provided.

31. The control arrangement as defined by claim 23, wherein for minimizing hysteresis of the pilot-controlled pressure limiting valve, underlying pressure regulation of a pilot control pressure of a pilot control valve is provided.
